(19) United States
(12) Patent Application Publication
(10) Pub. No.: US 2002/0101687 A1
(43) Pub. Date: Aug. 1, 2002

(54) Disc drive actuator bearing positioned within the disc outer circumference

(76) Inventor: Karl Arnold Belser, San Jose, CA (US)

Correspondence Address: Jonathan E. Olson, Seagate Technology LLC, Intellectual Property - LLC, 389 Disc Drive, Longmont, CO, 80530, US

(21) Appl. No.: 09/773,975

(22) Filed: Jan. 31, 2001

Related U.S. Application Data
(60) Provisional application No. 60/225,255, filed on Aug. 15, 2000.

(51) Int. Cl. G11B 5/55

(52) U.S. Cl. 360/264.3

(57) ABSTRACT

A disc drive has a disc for storing information with the disc having a radius and an outer circumference. The actuator assembly is rotatable about a rotational axis with the rotational axis of the actuator assembly being positioned within the outer circumference of the disc. The length of the actuator assembly between the magnetic head and the rotational axis being less than or equal to the radius of the disc. A method for securing an actuator assembly within a disc drive is also provided.

### RELATED APPLICATIONS

This application claims t he benefit of U.S. Provisional Application No. 60/225,255, filed on Aug. 15, 2000.

### FIELD OF THE INVENTION

The present invention relates generally to an actuator assembly in a disc drive, and more particularly to an actuator assembly having a rotational axis positioned within the outer circumference of the disc and with the length of the actuator assembly between the magnetic head and the rotational axis being less than or equal to the radius of the disc.

### BACKGROUND OF THE INVENTION

Generally, the disc drive, used as an auxiliary memory device in a computer or the like, includes at least one disk, which is rotated at a high speed by a spindle motor, and an actuator arm assembly having an actuator body and a bearing cartridge. The actuator body has at least one actuator arm that is balanced and rotates in response to a voice coil motor about a pivot point. The actuator arm body is typically composed of two parts, namely, the actuator arm constructed from an aluminum material and a suspension constructed from steel material. The actuator arm and suspension are joined by swedging a steel ball through the suspension and into a hole on the actuator arm. Unfortunately, the swedged ball can actually distort the suspension slightly when the suspension is attached to the actuator arm, which causes the suspension modes to become excited by force from the motor or from the airflow across the actuator arm.

The actuator arm and suspension can be lightened by forming holes in the actuator arm and the suspension thereby lowering the inertia of the actuator assembly and, in turn, lowering the track-to-track seek time. Holes in the actuator arm or suspension, however, can cause whistling which is sensitive to the angle of the actuator arm relative to the airflow from the disc.

The actuator arm moves a magnetic head at a distal end of each actuator arm. The magnetic head writes data onto the tracks of the disc and reads the data recorded on the tracks of the disc. The magnetic head moves in proximity to the disc, wherein the magnetic head is influenced by an airflow generated on a surface of the disc as the disc rotates at a high speed to maintain a minute gap between the magnetic head on the actuator arm and the disc.

Unfortunately, there are many factors that limit the performance of conventional actuator assemblies. For example, with multiple actuator arms driven in parallel, the dynamic interaction between the actuator arms result in a complicated resonant mode structure that is very sensitive to small changes due to tolerances and temperature. These modes, called unmodelled dynamics, can actually limit the servo bandwidth. Additionally, the actuator arms usually do not rotate through a very large angle when following tracks on the disc. The wires forming the moving coil, the recording head, and the pivot bearing add a spring force causing a variable force type of disturbance called hysteresis. The fine structure of the coil causes additional modes that are subject to tolerances during assembly. Furthermore, because the moving coil has a very poor heat flow path, it is possible to get thermal “run-away” when the coil is driven by a constant current source thereby limiting actuator assembly acceleration.

Typically, the actuator size is constrained by the disk diameter when there are multiple arms because the pivot bearing has to be placed outside of the outer circumference of the disk. The actuator bandwidth has to improve as the track density gets higher. If the disk diameter is reduced the single stage actuator performance can be increased at the expense of disk drive capacity. Because the cost per gigabyte of disk storage is commercially important one must improve the actuator bandwidth without changing the disk diameter. This size constraint has led to the proposed usage of two stage actuators assuming that the disk diameter does not change. The first stage actuator is the conventional actuator with relative low bandwidth and a long stroke. The second stage is a micro motor between the end of the suspension and the recording head. The second stage actuator has a high bandwidth and a short stroke.

A need therefore exists in the art for a smaller and, hence, higher bandwidth actuator assembly with a long stroke in which the rotational axis of the actuator is positioned within the outer circumference of the disc. Specifically, the length of the actuator assembly between the magnetic head and the rotational axis would be less than or equal to the radius of the disc. It is desirable that this be achieved, moreover, without compromising the actuator assembly performance and the interface between the actuator body and bearing cartridge. The present invention solves these problems and offers other advantages over the prior art.

### SUMMARY OF THE INVENTION

These and various other features as well as advantages which characterize the present invention will be apparent upon reading of the following detailed description and review of the associated drawings. The present invention is an actuator assembly for a disc drive. The actuator assembly has a magnetic head. The disc drive has a disc for storing information with the disc having a radius and an outer circumference. The actuator assembly comprises an actuator body rotatable about a rotational axis with the rotational axis of the actuator assembly being positioned within the outer circumference of the disc. The length of the actuator assembly between the magnetic head and the rotational axis is less than or equal to the radius of the disc.

The present invention additionally includes a disc drive having a rotating disc for storing information. The disc has a predetermined radius and an outer circumference. The disc drive comprises a housing surrounding the disc. An aperture is formed in the housing with the aperture positioned within the outer circumference of the disc. An actuator reads information from and writes information to the disc and rotational means are receivable within the aperture of the housing for rotatably securing the actuator body to the housing.

The present invention further includes a method for rotatably securing an actuator within a disc drive. The actuator has a magnetic head and a rotational axis. The disc drive has a housing for surrounding the actuator and at least one disc with each disc having a predetermined radius and an outer circumference. The method comprises steps of providing the actuator with a length between the magnetic head and the rotational axis less than the radius of the disc and positioning the rotational axis of the actuator within the outer circumference of the disc.

The present invention still further includes a method for mounting an actuator within a disc drive. The disc drive has at least one disc with a housing surrounding the actuator and the at least one disc. Each disc has an outer circumference. The method comprises steps of forming a first aperture in the actuator, providing a bearing cartridge for rotating the actuator, securing at least a portion of the bearing cartridge within the first aperture, forming a second aperture in the housing, the second aperture positioned within the outer circumference of the at least one disc, and securing at least a portion of the bearing cartridge within the second aperture.

### BRIEF DESCRIPTION OF THE DRAWINGS

FIG. 1 shows a top plan view of a disc drive incorporating an actuator assembly of the present invention.

FIG. 2 shows another top plan view of a disc drive incorporating the actuator assembly implementing the present invention.

FIG. 3 shows a perspective view of a disc drive implementing the actuator assembly of the present invention.

FIG. 4 shows a sectional side view of the actuator assembly of the present invention.

FIG. 5 shows a top plan view of the actuator assembly of the present invention.

FIG. 6 shows a sectional side view of the actuator assembly of the present invention taken along line 6-6 in FIG. 5.

FIG. 7 shows a plan view of the skewed rail of the actuator assembly of the present invention.

### DETAILED DESCRIPTION

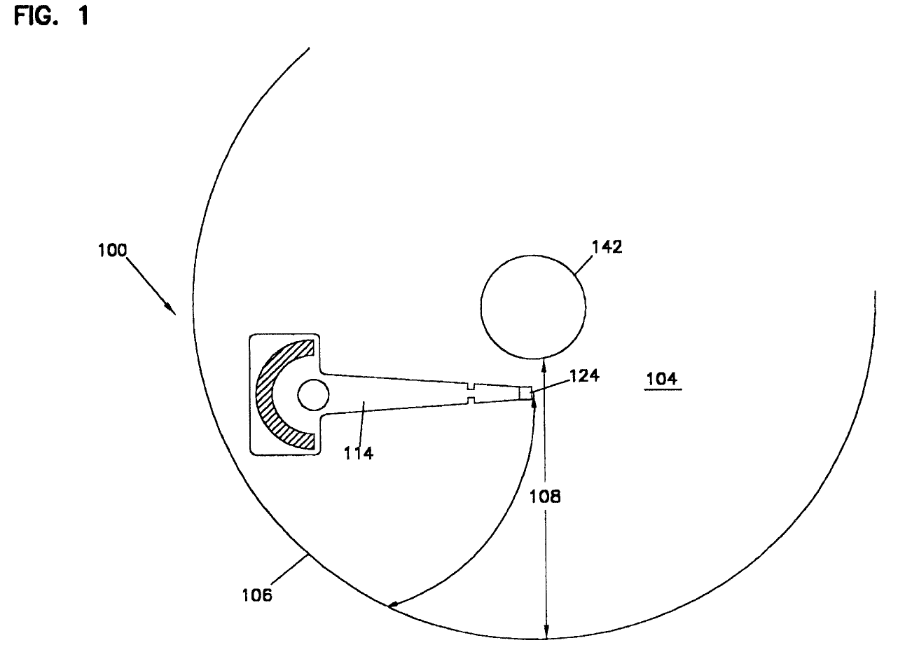

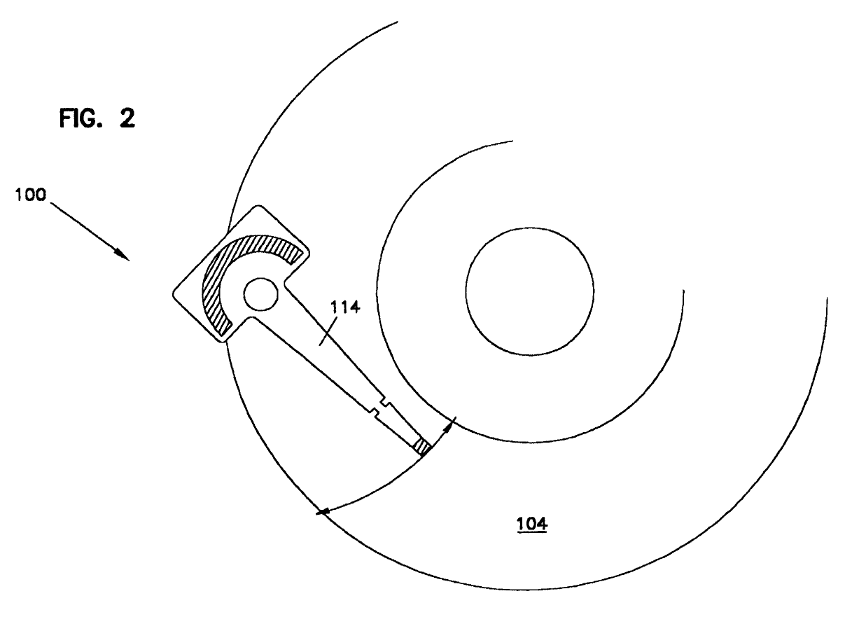

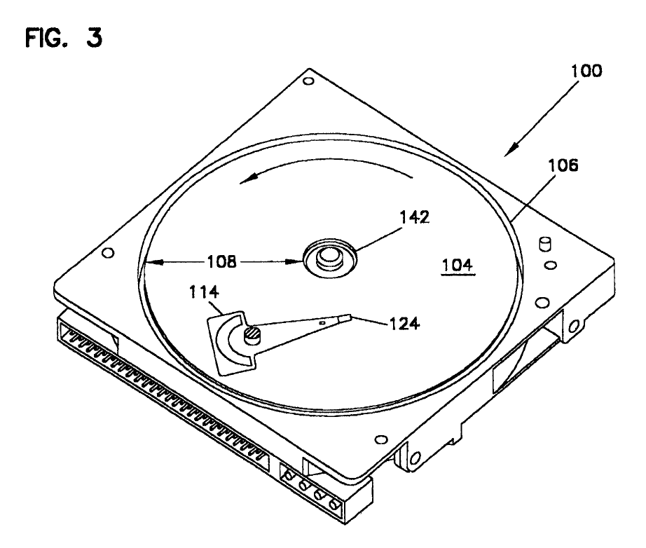

As illustrated in FIG. 1, FIG. 2, and FIG. 3, the present invention includes an actuator assembly in a disc drive having at least one disc 104 rotatable therein. Each disc 104 has an outer circumference 106 and a data surface width 108. The disc stack is supported on a spindle motor 142. The actuator assembly 100, like the one illustrated in FIG. 1, has an axis of rotation 109 positioned within the outer circumference 106 of each disc 104 with the radial length of the actuator assembly (between a magnetic head 124 and rotational axis 109, as shown) being less than or equal to the data surface width 108 of each disc 104.

The disc drive incorporating the actuator assembly of the present invention includes a base plate 110 and a top plate 112 for surrounding each disc 104 and the actuator assembly 100. The base plate 110 and the top plate 112 of the disc drive 102 protect each disc 104 and the actuator assembly from any foreign objects and the like which could damage or otherwise interfere with the operation and performance of the actuator assembly and each disc 104.

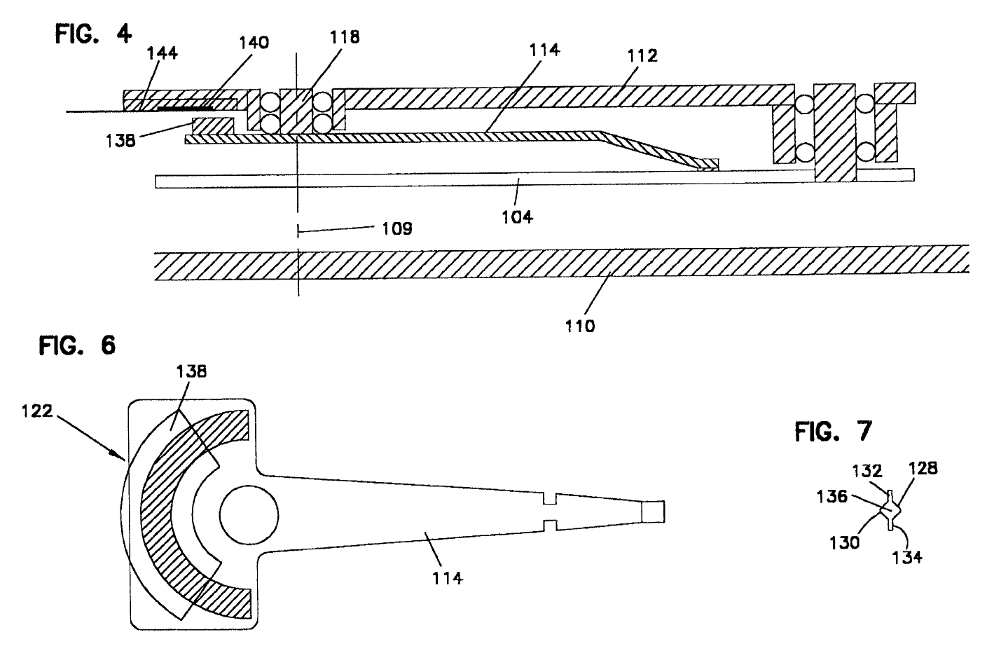

As illustrated in FIG. 4, the actuator assembly includes an actuator body 114 and a bearing cartridge 118. The actuator body 114 is mounted to the bearing cartridge 118 by any method. In a single arm application, as will be discussed further below, the actuator body 114 is preferably glued or welded to the bearing cartridge 118. In a multiple arm application, the actuator body 114 includes a bearing-receiving aperture (not shown) with at least a portion of the bearing cartridge 118 being receivable within the bearing-receiving aperture. In an embodiment of the present invention, the bearing cartridge 118 is preferably a cantilever rotary bearing for increased rotational performance, although utilizing other types of bearing cartridge 118 is within the scope of the present invention.

As further illustrated in FIG. 1, the actuator body 114 includes at least one actuator arm and a moving magnet motor 122. Each actuator arm includes at least one magnetic recording head 124, as illustrated in FIG. 1 and FIG. 2, at a distal end of each actuator arm. The moving magnet motor 122 moves each magnetic recording head 124 along one side of each disc 104 for writing data onto the tracks (not shown) of each disc 104 and reading the data recorded on the tracks of the disc 104.

To minimize the angular range over which the air bearing slider has to fly for the actuator assembly, as illustrated in FIG. 5, the magnetic head 124 includes a skewed slider air-bearing rail 126. The skewed rail 126 of the magnetic head 124 provides a large usable skew angle range of the actuator assembly of the present invention. The skew angle range of the actuator assembly will be discussed in further detail below.

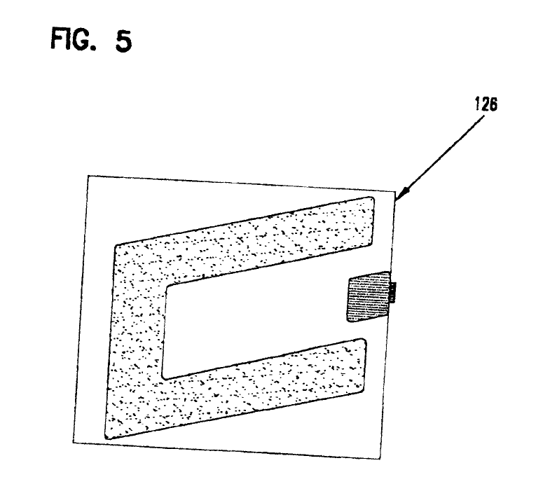

As illustrated in FIG. 6 and FIG. 7, the actuator arm of the actuator assembly of the present invention is constructed from a first actuator arm member 128 and a second actuator arm member 130. The first actuator arm member 128 is connected to the second actuator arm member 130 forming a first actuator arm edge 132 and second actuator arm edge 134 and thereby defining an actuator arm cavity 136. The first actuator arm member 128 can be connected to the second actuator arm member 130 by spot welding although any type of connection between the first actuator arm member 128 and the second actuator arm member 130 is within the scope of the present invention. Further the shapes of the two pieces of the arm do not have to be the same. One could be flat and the other a curved or rectangular channel, for example. Preferably, the first actuator arm edge 132 and the second actuator arm edge 134 are designed to minimize wind resistance during operation of the disc drive 102.

Preferably, the actuator body 114 is constructed from a steel material, which can undergo countless stress-strain cycles without failing. An actuator body 114 constructed from a steel material is non-toxic, inexpensive, and simple to manufacture.

While the actuator assembly 100 of the present invention is suited for both a stacked actuator arm application and a single arm application, in an embodiment of the present invention, a single actuator body 114 supporting a single magnetic head 124 is utilized.

As illustrated in FIG. 3, the moving magnet motor 122 includes a magnet 138, or group of magnets, positioned on the actuator body 114 of the actuator assembly and a stationary coil 140 positioned on the top plate 112 and/or the base plate 114 of the disc drive 102 relative to the magnet 138. As a disc drive controller (not shown) causes current to flow through the coil 140, the current within coils of the stationary coil 140 interact with the magnetic field provided by the magnet 138 and cause rotation of the actuator assembly about the axis of rotation 109 thereby moving the magnetic head 124 at the distal end of each actuator body 114 across each disc 104.

Preferably, as described above, a “moving magnet” is utilized for the actuator assembly of the present invention to inhibit coil dynamics as an actuator assembly performance limit. The coil 140 is maintained in stationary configuration by heat sinking, for instance, the coil 140 into the top plate 112 and/or the base plate 114. The coil 140 does not move thereby allowing large currents to be driven into the coil 140 and increasing actuator assembly performance. It should be noted, however, that while a moving magnet motor 122 has been described for use with the actuator assembly of the present invention, any type of moving magnet or moving coil motor 122 is within the scope of the present invention.

The actuator assembly of the present invention is preferably sized and shaped for increased actuator assembly performance. In an embodiment of the present invention, the actual length of the actuator assembly between the magnetic head 124 and the rotational axis 109 is less than the radius 108 of each disc 104. By reducing the length of the actuator assembly as described, the actual cost of the manufacturing of the actuator assembly is reduced since the normal and conventional size of each disc 104 can be maintained. In general, since the cost of materials used in the actuator assembly is proportional to size, a half sized actuator assembly could achieve one-eighth (⅛th) of the materials cost as compared to a conventional actuator assembly.

In addition to the smaller and increased performance of the actuator assembly of the present invention, higher performance is achieved. If the actuator arm had a length equal to one-half of the radius of the disc 104, then the actuator arm would be approximately tangent to the inside diameter track of the disc 104. In this case, the skew angle, i.e., the angle between the tangent of the disc 104 and the actuator arm 120, would be approximately zero (0°) degrees. When this actuator arm rotates to the outside diameter track of the disc 104, the skew angle would be approximately forty (40°) degrees. If the air bearing slider rails were parallel to the body of the slider, this 40 degree skew angle range would be difficult to accommodate by practical air bearing designs. Therefore, the skewed rail 126 of the actuator assembly has rotated rails providing a skew angle of approximately negative twenty (−20°) degrees at the inside diameter track and a skew angle of approximately twenty (20°) degrees at the outside diameter track. The skewed rail 126 thereby increases the performance of the disc drive 102. Thus, the actuator assembly of the present invention eliminates the need for a second stage actuator. The actuator has a small size and a high servo bandwidth as well as a long stroke.

Furthermore, if the recording elements of the head are perpendicular to the edges of the slider body, then the high skew angle of the slider body at the outside circumference of the disk results in a narrower track. That is, the track width is proportional to the cosine of the skew angle of the slider body relative to the track. If the areal density, i.e., the product of track density times bit density, is constant everywhere on the disk surface, then the bit density will be lower at the outside circumference compared to that of the inside circumference of the data zone. This lower bit density at the outside circumference is advantageous because the data rate will also be lower. This lower data rate will allow the disk to spin faster for the same electronic noise level, or alternatively it will allow a lower electronics noise that may in turn allow the areal density to be higher than it would otherwise be.

The present invention can be summarized in reference to FIGS. 1-4, which are views of the preferred embodiment actuator assembly for a disc drive 102. The actuator assembly has a magnetic head 124. The disc drive 102 has a housing 110, 112 surrounding at least one disc 104 for storing information with each disc 104 having an outer circumference 106 and a radius 108. The actuator assembly of the present invention comprises an actuator body 114 rotatable about a rotational axis 109. The rotational axis 109 of the actuator assembly is positioned within the outer circumference 106 of each disc 104 with the length of the actuator assembly between the magnetic head 124 and the rotational axis 109 being less than or equal to the radius 108 of each disc 104.

In an embodiment of the present invention, the actuator body 114 is rotationally balanced about the rotational axis 109. Furthermore, preferably, the actuator body 114 is constructed from a first member 128 and a second member 130 with the first member 128 being connected to the second member 130 thereby defining a cavity 136 having a first edge 132 and a second edge 134. In addition, preferably, the first member 128 and the second member 130 are constructed from a steel material.

In another embodiment of the present invention, the actuator assembly of the present invention further comprises a bearing assembly 118 for rotatably connecting the actuator body 114 to the housing 110, 112. Preferably, the bearing assembly 118 is a cantilever rotary bearing. Furthermore, the actuator assembly can include a bearing-receiving aperture formed in the actuator body 114 for receiving at least a portion of the bearing assembly 118.

In still another embodiment of the present invention, the actuator assembly of the present invention further comprises a voice coil motor assembly 122 having a voice coil 140 and at least one magnet 138 wherein the voice coil 140 is mounted to the housing 110, 112 and the magnet 138 is mounted to actuator body 114.

In yet another embodiment of the present invention, the disc drive 102 has external drive electronics (not shown) for controlling the operation of the disc drive 102, and the actuator assembly of the present invention further comprises a multiple wire signal cable 144 for electrically connecting the magnetic head 124 to external drive electronics.

All of the structures described above will be understood to one of ordinary skill in the art, and would enable the practice of the present invention without undue experimentation. It is to be understood that even though numerous characteristics and advantages of various embodiments of the present invention have been set forth in the foregoing description, together with details of the structure and function of various embodiments of the invention, this disclosure is illustrative only. Changes may be made in the details, especially in matters of structure and arrangement of parts within the principles of the present invention to the full extent indicated by the broad general meaning of the terms in which the appended claims are expressed. For example, the particular elements may vary depending on the particular application for the present system while maintaining substantially the same functionality, without departing from the scope and spirit of the present invention. In addition, although the preferred embodiments described herein are largely directed to non-removable, hard disc drives, it will be appreciated by those skilled in the art that the teachings of the present invention can be applied to other disc drive systems such as flying head optical disk drives, micro drives, removable floppy disk drives, and removable hard disk drives without departing from the scope and spirit of the present invention.

What is claimed is:

1. A disc drive comprising:
a housing;
a disc rotatably supported within the housing, the disc having an outer circumference and a radius; and
an actuator rotatable about a rotational axis within the outer circumference, the actuator including a head having a distance D to the rotational axis that is smaller than the radius of the disc.

2. The disc drive of claim 1 in which the disc has a data surface having a radial width greater than D.

3. The disc drive of claim 1 and further comprising a bearing assembly for rotatably connecting the actuator to the housing.

4. The disc drive of claim 3 in which the bearing assembly is a cantilever rotary bearing.

5. The disc drive of claim 3 and further comprising an aperture formed in the actuator body for receiving at least a portion of the bearing assembly.

6. The disc drive of claim 1 and further comprising a moving magnet motor assembly having a coil and at least one magnet, in which the coil is mounted to the housing and the magnet is mounted to actuator body.

7. A method of mounting an actuator assembly within the disc drive of claim 1, comprising steps of:
(a) forming a first aperture in the actuator;
(b) securing at least a portion of the rotational means within the first aperture;
(c) forming a second aperture in the housing, the second aperture positioned within the outer circumference of the at least one disc; and
(d) securing at least a portion of the rotational means within the second aperture.

8. A disc drive having a rotating disc for storing information, the disc having a predetermined radius and an outer circumference, the disc drive comprising:
a housing surrounding the disc;
an aperture in the housing positioned within the outer circumference of the disc;
an actuator configured for reading information from and writing information to the disc; and
rotational means receivable within the aperture of the housing for rotatably securing the actuator body to the housing.

9. The disc drive of claim 8 in which the rotational means is a cantilever rotary bearing.

10. The disc drive of claim 8 in which actuator is rotationally balanced about the rotational means.

11. The disc drive of claim 8 in which the actuator is constructed from a unitary piece of material.

12. The disc drive of claim 11 in which the material is steel.

13. The disc drive of claim 11, further comprising a coil motor assembly having a coil and at least one magnet, in which the coil is mounted to the housing and the magnet is mounted to actuator.
